(19) United States
(12) Patent Application Publication
(10) Pub. No.: US 2015/0160082 A1
(43) Pub. Date: Jun. 11, 2015

(54) SYSTEM AND METHOD FOR MEASURING TORQUE

(71) Applicant: Advanced Test and Automation Inc., Milton (CA)

(72) Inventors: Anthony Khoraych, Milton (CA); Hamidreza Alemohammad, Kitchener (CA); Dusan Mandic, Kitchener (CA); Leanne Stodola, Etobicoke (CA)

(73) Assignee: Advanced Test and Automation Inc., Milton, ON (CA)

(21) Appl. No.: 14/415,664

(22) PCT Filed: Jul. 22, 2013
(86) PCT No.: PCT/CA2013/000661

§ 371 Date: Jan. 19, 2015

Related U.S. Application Data
(60) Provisional application No. 61/674,032, filed on Jul. 20, 2012.

(51) Int. Cl. G01L 3/12; G01L 3/08

(52) U.S. Cl. CPC G01L 3/12; G01L 3/08

(57) ABSTRACT

A system for measuring torque to which a body is subjected by twisting the body about an axis defined thereby. The system includes one or more fiber Bragg gratings secured to the body. Each of the fiber Bragg gratings is positioned so that the fiber Bragg grating is located at least partially non-parallel with the axis of the body. The system also includes one or more light sources for providing light transmittable to the fiber Bragg grating(s). The light transmitted to the fiber Bragg grating(s) is filtered thereby to provide a modified light having one or more characteristic spectra. The sys tem also includes an analyzer for analyzing said at least one characteristic spectrum to determine the torque to which the body is subjected.

### CROSS REFERENCE TO RELATED APPLICATIONS

This application claims the benefit of U.S. Provisional Patent Application No. 61/674,032, filed on Jul. 20, 2012, the disclosure of which is incorporated fully herein by reference.

### FIELD OF THE INVENTION

The present invention is a system and a method for measuring torque to which a body is subjected.

### BACKGROUND OF THE INVENTION

Strain-based sensing devices (e.g., strain gauges) are key components of measurement and test equipment in many applications, e.g., in the automotive industry, aerospace, and energy production plants. In particular, strain-based sensing devices are frequently utilized in rotational systems, where there is a need to determine the torque to which a rotating shaft is subjected. Engine crankshafts, gas turbine shafts, and wind turbine gearboxes are examples of rotational systems. When it comes to mechanical systems test and measurement, torsion (i.e., torque) measurement and control is a key aspect of these rotating components.

However, the typical strain-based sensing devices have a number of disadvantages. The conventional and commercialized methods of measurements in rotational systems, based on strain gauges, are vulnerable to electromagnetic noise and disturbance and suffer from high signal-to-noise ratio, particularly at very low strain values. They also suffer from short operational life, due to operating in harsh environments. In addition, the existence of additional components to provide “isolated electric power” and transmit the measurement signal to reading devices makes them bulky. RF digital telemetry or digital encoders have been proposed to overcome these issues, however, these systems cost two or three times more than a standard system.

The ever-increasing demands for high-resolution and accurate measurements call for the development of new types of sensors with long-range linear response and low sensitivity to electromagnetic noise and disturbances. Among the new types of sensors are optical fiber sensors. Apart from their well-known telecommunication applications, optical fiber sensors, such as fiber Bragg gratings (FBG), can be used for sensing physical parameters such as temperature, strain, pressure, displacement with applications in a variety of sectors including, for example, automotive, aerospace, civil, medical, energy production and sustainability, and oil and gas. The sensing capabilities of FBGs, made of fused silica, stem from the in-fiber light propagation affected by physical parameters such as, in particular, temperature and strain. This can be realized by the temperature and/or strain induced changes of the optical properties of the fiber material and the geometrical features of the in-fiber optical gratings.

In FBGs, the input light spectrum is filtered and a portion of the input light spectrum at a specific wavelength, called Bragg wavelength (λ_{B}) with a constant bandwidth defined by its Full-Width Half Maximum (FWHM), is reflected from the FBG. All other wavelengths of the light are transmitted through the FBG. The Bragg wavelength is correlated to the effective mode index of refraction (n_{eff}) of optical fiber and the grating pitch (Λ), as λ_{B}−2n_{eff} Λ. Since Λ and n_{eff} are linearly correlated to strain and temperature, any change in these parameters results in the shift of the Bragg wavelength. As a result, the Bragg wavelength can be correlated linearly to temperature (FIG. 1A) and strain (FIG. 1B). As shown in FIG. 1A, for example, a reflection spectrum 10 is shifted and changed due to increasing temperature to result in a modified reflection spectrum 10′. Similarly, in FIG. 1B, a reflection spectrum 12 is shifted and broadened due to increasing strain to result in another modified reflection spectrum 12′. (As will be described, the remainder of the drawings illustrate the present invention.)

Compared to their electromagnetic counterparts, optical fiber sensors possess unique features: light weight, small size, robustness to electromagnetic noise (the optical wave is not affected by noise), long-range linearity, durability, resistance to corrosion (the fiber is made of glass which is resistant to most chemicals), and low-loss remote sensing (optical signal transmission is not affected by Ohmic losses).

Despite the aforementioned distinguishing features of FBGs, temperature compensation of FBGs integrated to mechanical components has been a problem for some time in the field of optical fiber sensors. Various methods and techniques have been invented for temperature compensated strain measurements with FGB sensors. In the prior art, there are various methods of temperature compensation.

Another known method involves measuring the parameter of interest modifying the shape of the FBG reflection or transmission spectrum (in particular, broadening the reflection or transmission spectrum) by creating a non-uniform strain. This is accomplished by changing the geometry of parts to which FGBs are integrated in such a way that mechanical loading (e.g., tensile or compressive force, pressure, etc.) causes a non-uniform, in particular, chirped grating. However, in all these methods, the geometry of the parts has to be modified in order to result in this chirped profile along the FBG. However, in many circumstances, this may not be feasible.

### SUMMARY OF THE INVENTION

For the foregoing reasons, there is a need for a system and a method of measuring torque that overcomes or mitigates one or more of the disadvantages of the prior art.

In its broad aspect, the invention provides a system for measuring torque to which a body is subjected by twisting the body about an axis defined thereby. The system includes one or more fiber Bragg gratings secured to the body, each fiber Bragg grating being positioned so that the fiber Bragg grating is located at least partially non-parallel with the axis of the body. The system also includes one or more light sources for providing light transmittable to the fiber Bragg grating. The light transmitted to the fiber Bragg grating(s) is filtered thereby to provide a modified light having one or more characteristic spectra. In addition, the system includes an analyzer for analyzing the characteristic spectrum to determine the torque to which the body is subjected.

In another aspect, the invention provides a method of measuring torque to which a body is subjected by twisting the body about an axis defined thereby. The method includes the steps of, first, securing one or more fiber Bragg gratings to the body so that the fiber Bragg grating is non-parallel with the axis of the body. Light is generated by at least one light source. The light is transmitted to the fiber Bragg grating for filtering of the light thereby to provide a modified light having one or more characteristic spectrum. The characteristic spectrum is analyzed to determine the torque to which the body is subjected.

### BRIEF DESCRIPTION OF THE DRAWINGS

The invention will be better understood with reference to the attached drawings, in which:

FIG. 1A (also described previously) is a graph illustrating the effect of temperature increases on a reflection spectrum;

FIG. 1B (also described previously) is a graph illustrating the effect of strain increases on a reflection spectrum, in the absence of temperature effects;

FIG. 2A is a schematic representation indicating axial strain at different locations on a cylinder;

FIG. 2B is a graph illustrating the relation between the position of a FBG on a cylinder relative to an axis of rotation of the cylinder to the proportion of maximum strain to which the FBG is subjected;

FIG. 3A is an illustration, in two dimensions, showing the location of an FBG in an embodiment of a shaft assembly of the invention, drawn at a larger scale;

FIG. 3B is a block diagram of an embodiment of a system of the invention;

FIG. 4A is a schematic illustration of one side of a cylinder showing a location of an embodiment of an optical circuit of the invention thereon, drawn at a smaller scale;

FIG. 4B is a schematic illustration of another side of the cylinder of FIG. 4B showing another location of the optical circuit of FIG. 4A thereon;

FIG. 4C is a schematic illustration of an embodiment of a shaft assembly of the invention, drawn at a smaller scale;

FIG. 4D is a schematic illustration of an alternative embodiment of the shaft assembly of the invention;

FIG. 4E is a cross-section of the shaft assembly of FIG. 4D, drawn at a larger scale;

FIG. 5 is a schematic illustration of an embodiment of an optoelectronic circuit of the invention;

FIG. 6 is an isometric view of another alternative embodiment of the shaft assembly of the invention, drawn at a smaller scale;

FIG. 7A is another alternative embodiment of the shaft assembly of the invention;

FIG. 7B is a plan view of a shaft element included in the shaft assembly of FIG. 7A, drawn at a smaller scale;

FIG. 7C is a cross-section of the shaft of FIG. 7B;

FIG. 8 is an isometric view of an embodiment of an electric motor of the invention in which the shaft assembly of FIG. 7A is mounted;

FIG. 9 is a graph illustrating an example of the effect of torque as measured by the system;

FIG. 10 is a graph illustrating another example of the effect of torque as measured by the system;

FIG. 11 is a graph illustrating an example of the effect of temperature as measured by the system;

FIG. 12 is a flow chart schematically illustrating an embodiment of a method of the invention;

FIG. 13 is a flow chart schematically illustrating another embodiment of the method of the invention;

FIG. 14 is a flow chart schematically illustrating another embodiment of the method of the invention;

FIG. 15 is a flow chart schematically illustrating another embodiment of the method of the invention; and

FIG. 16 is a flow chart schematically illustrating another embodiment of the method of the invention.

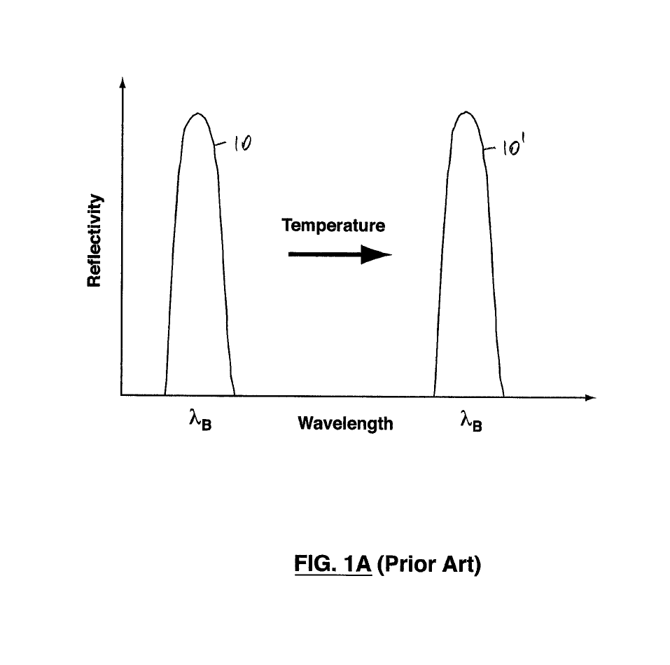

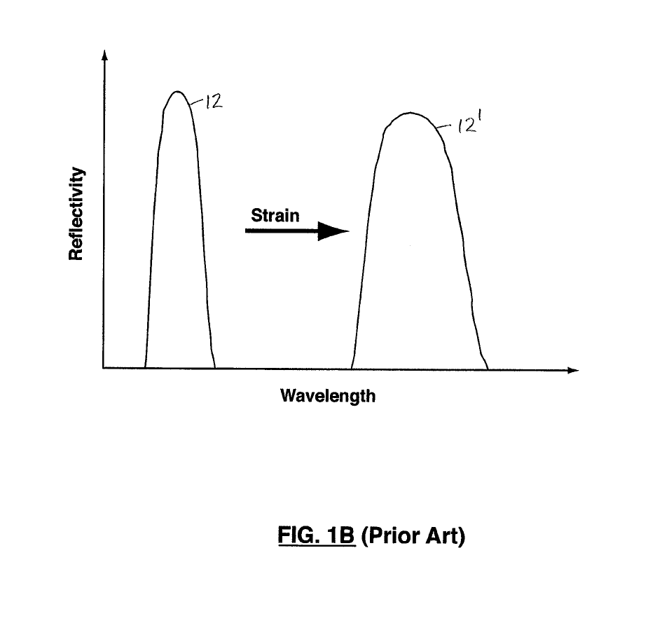

### DETAILED DESCRIPTION

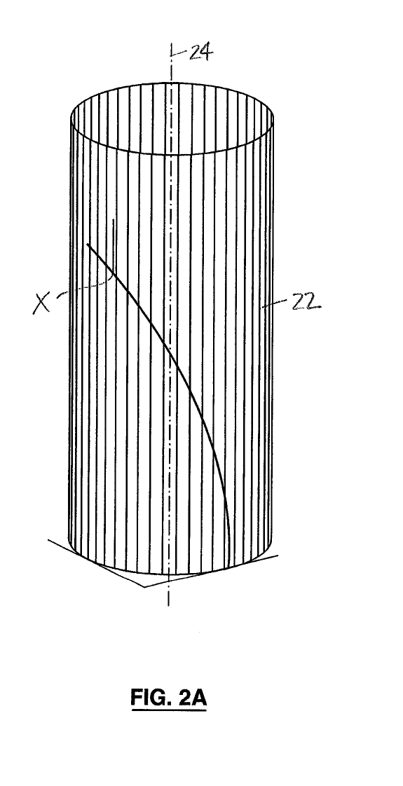

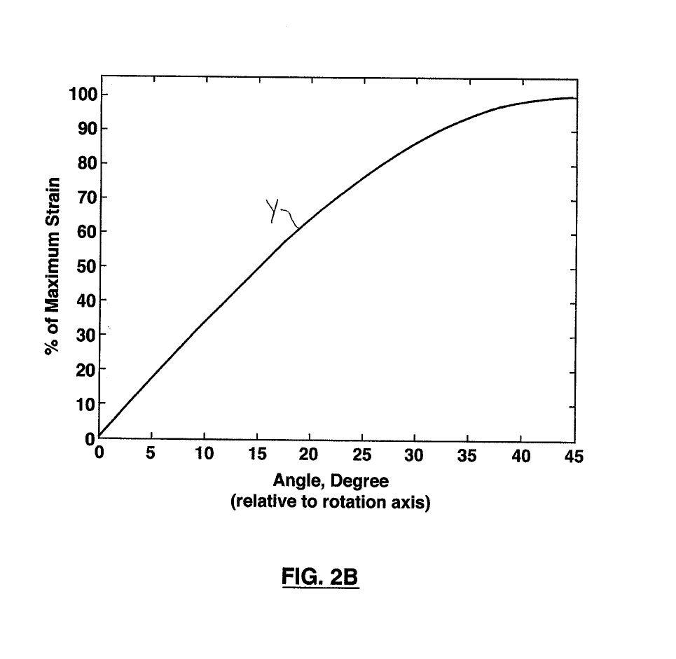

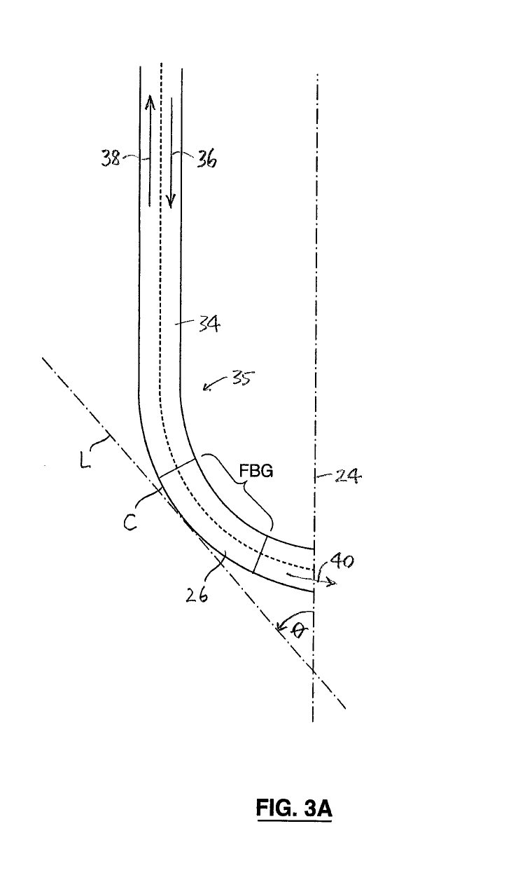

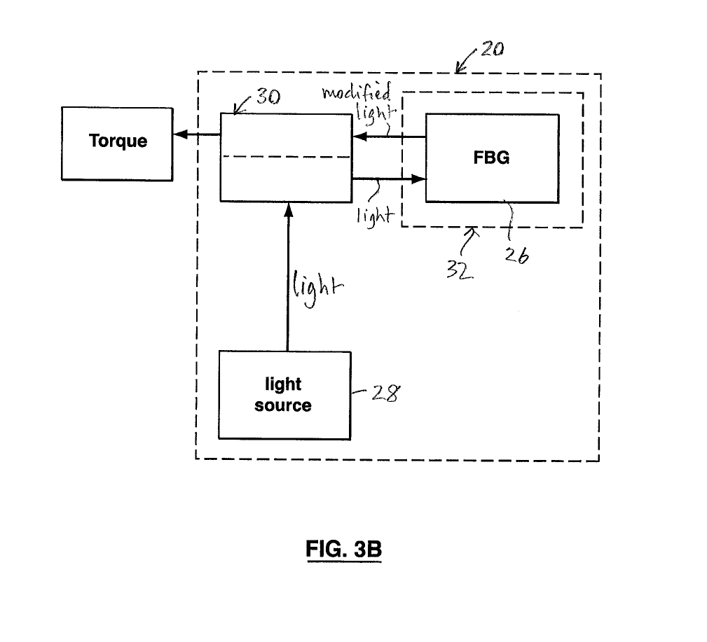

In the attached drawings, like reference numerals designate corresponding elements throughout. Reference is first made to FIGS. 2A-13 to describe an embodiment of a measuring system in accordance with the invention indicated generally by the numeral 20 (FIG. 3B). The system 20 is for measuring torque to which a body 22 is subjected by twisting the body about an axis 24 defined thereby (FIG. 2A). In one embodiment, the system 20 preferably includes one of more fiber Bragg gratings 26 secured to the body 22 (FIG. 3A). As will be described, the fiber Bragg grating 26 preferably is positioned so that it is located at least partially non-parallel with the axis 24 of the body 22 (FIG. 3A). As can be seen in FIG. 3B, the system 20 preferably also includes one or more light sources 28 for providing light transmittable to the fiber Bragg grating 26. The light transmitted to the fiber Bragg grating 26 is filtered thereby to provide a modified light having one or more characteristic spectra. It is also preferred that the system 20 includes an analyzer 30 (FIG. 3B) for analyzing the characteristic spectrum to determine the torque to which the body 22 is subjected, as will also be described.

For practical reasons (discussed below), it is preferred that two or more FBGs 26 are utilized to measure torque. However, for the purposes hereof, the following description is initially limited to one FBG only, positioned non-parallel with the axis. It will be understood that, in one embodiment, torque may be determined using one FBG positioned non-parallel with the axis.

Also, it will be understood that the body 22 is not necessarily a cylindrical, rotatable shaft. For instance, the FBG is illustrated in FIG. 2A as being positioned on a cylindrical shaft, for clarity of illustration.

Preferably, one or more FBGs 26 are positioned on the cylindrical shaft 22 in predetermined locations using any suitable method, to provide a shaft assembly 32. Considering the case of a cylindrical shaft, the normal strain due to torque on any cylindrical object in the axial direction is zero, and increases reaching an absolute maximum at 45° relative to the axial direction (FIGS. 2A, 2B).

Accordingly, in the invention herein, one or more of the FBGs are secured to the shaft in a position that is at least partially non-parallel to the axis 24. This results preferably in a non-uniform grating pitch variation and a non-uniform change of the index of refraction. Because of this, the FBG provides modified light (i.e., light at the Bragg wavelength) that directly corresponds to a strain gradient resulting from torque to which the shaft is subjected. As will be described, the modified light has a characteristic spectrum that may be analyzed to determine torque.

With the curve “Y”, FIG. 2B illustrates the effect of angular positioning of the FBG (relative to the rotation axis) on torque measurement, and consequently also on strain measurement. For example, if the FBG is placed on a curved location “X” (FIG. 2A) on a curved surface of the shaft so that all or part of the curve “Y” represents the strain transferred to the FBG from the shaft, the characteristic spectrum, when torque is applied to the shaft, is broader than the corresponding initial spectrum, i.e., in the absence of torque. Subjecting the FBG to substantially uniform torque along its length, when the FBG is positioned in the preselected location “X” (FIG. 2A), i.e., along a curve, results in non-uniform strain along the FBG, in turn resulting in modified light exiting therefrom having one or more characteristic (i.e., broadened) spectra. (The characteristic spectra may be one or more reflection spectra, or one or more transmission spectra.)

As noted above, the maximum strain is at 45° relative to the axis 24. Accordingly, in one embodiment, it is preferred that the FBG is measured when the FBG is located to define an angle θ of approximately 45° between the FBG 26 and the axis 24. This arrangement is illustrated in FIGS. 2A and 3A.

From the foregoing, it can be seen that the FBG 26 preferably is secured to the shaft so that the axial strain on the FBG 26 changes continuously from zero to maximum strain, when the body 22 is subjected to torque. This results in non-uniform grating pitch variation and a non-uniform change of the FBG's index of refraction due to photoelasticity. The reflection or transmission spectrum of the FBG, as the case may be, broadens as a result of the axial non-uniform strain.

It would be appreciated by those skilled in the art that the light source 28 may be any suitable light source. Whether the temperature of the shaft affects the determination of torque depends, in part, on the light that is used. For example, the light source may be a light-emitting diode (LED), a tunable laser, a Fabry-Perot laser, or a super-luminescent diode (i.e., ASE (amplified spontaneous emission)). In one embodiment, the light source is selected from the group consisting of a light-emitting diode (LED), a tunable laser, a Fabry-Perot laser, or a super-luminescent diode. Those skilled in the art would appreciate that the foregoing list of light sources is a list of alternatives, i.e., only one light source type preferably is utilized at any one time.

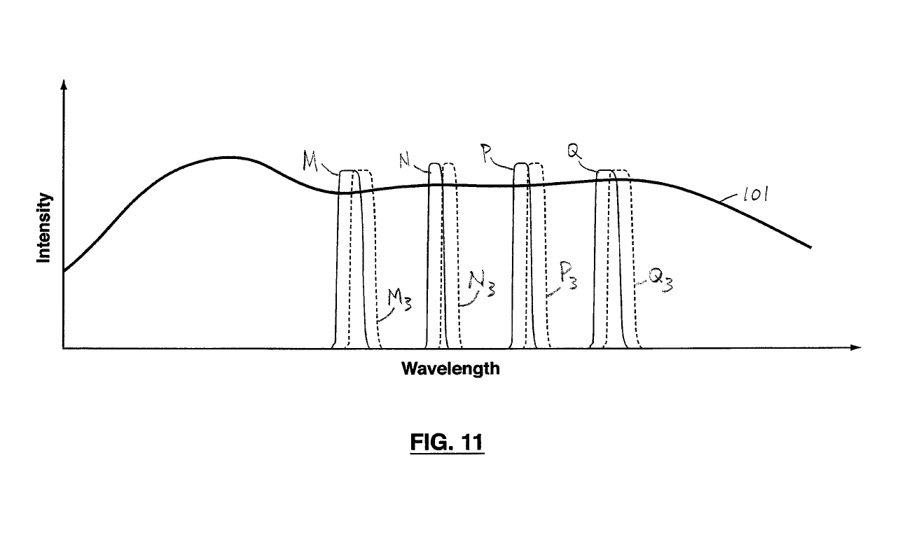

As can be seen in FIG. 11, the intensity of the light produced by ASE is not constant across all wavelengths, the and due to this, there is a power change due to a temperature change. In one embodiment (e.g., where ASE light is used), it is preferred that the temperature is taken into account when determining torque. Because the FBG is secured to the shaft 22, the thermal sensitivity of the sensor is non-directional, i.e., temperature change does not induce non-uniform strain on the FBG. As a result, temperature only shifts the reflection (or transmission, as the case may be) spectrum and does not impact the signal widening or band width increase.

As can be seen in FIG. 3A, the light and the modified light preferably are transmitted via one or more optical fibers 34. The FBG 26 preferably is substantially aligned with the optical fiber 34. (The light source 28 and related elements are omitted from FIG. 3A for clarity of illustration.) In the example illustrated in FIG. 3A, the optical fiber 34 and the FBG 26 are shown as having approximately the same diameter. The FBG 26 is positioned on the shaft at an angle of approximately 45° to the axis 24. As can be seen in FIG. 3A, the FBG 26 preferably is positioned on the body 22 to at least partially define a curve “C”. A substantially straight line “L” tangential to the curve “C” preferably defines an angle between the line “C” and the axis 24 that is approximately 45° (FIG. 3A).

Those skilled in the art would appreciate that the optical fiber(s) 34 preferably are secured to (i.e., in or on) the body 22 for light transmission therethrough to (and from) the FBG 26. As can be seen in FIG. 3A, it is preferred that the shaft assembly 32 includes the shaft 22, the FBG 26, and the optical fiber 34 optically connected to the FBG 26. (Those skilled in the art would also appreciate that the optical fiber and the FBG are not drawn to scale in the drawings, but have been exaggerated for clarity of illustration.) An optical circuit 35 preferably includes the optical fiber(s) 34 and the FBG(s) 26 included in a shaft assembly 32. Those skilled in the art would also be aware of various ways in which the optical fiber and the FBG may be secured to the body.

In one embodiment, the light preferably is produced by ASE (amplified spontaneous emission). Those skilled in the art would appreciate that a number of factors may influence the selection of a light source, including, for example, the specific application in which the system 20 is to be utilized. In one embodiment, the ASE light source is preferred due to its relatively low cost, and also the relatively low cost of the components of the analyzer 30 that may be used because the light is produced by ASE. It would be appreciated by those skilled in the art that, although the preferred light source in one embodiment (i.e., ASE) produces broadband light, other light sources may be preferred in other embodiments.

In one embodiment, light from the light source 28 preferably is transmitted along the optical fiber 34, as schematically indicated by arrow 36 (FIG. 3A). The modified light reflected from the FBG 26 is transmitted along the optical fiber 34, as schematically indicated by arrow 38 in FIG. 3A. As will be described, the modified light is ultimately transmitted to the analyzer 30, for determining torque.

Those skilled in the art would appreciate that all other wavelengths of the light are transmitted through the FBG 26, as schematically illustrated by arrow 40 in FIG. 3A.

In one embodiment, the body 22 preferably is a rotatable shaft. In another embodiment, the rotatable shaft 22 preferably is driven by a motor 42 (FIG. 8) in which the rotatable shaft is mounted. It will be understood that the rotatable shaft herein is not necessarily cylindrical. For instance, the invention herein may be used with a rotatable shaft having a non-circular cross-section (e.g., square, cruciform, irregular).

Where the body 22 is a rotatable shaft, it is preferred that the light from the light source 28 is transmitted to the optical fiber 34 by a rotary optical joint 44 (FIG. 8). As will be described, the optical fiber 34 preferably is partially positioned inside and coaxial with the shaft in order to connect with the rotary optical joint 44. Those skilled in the art would appreciate that the rotary optical joint 44 preferably is a fiber optic rotary joint (FORJ), and would be aware of suitable rotary optical joints.

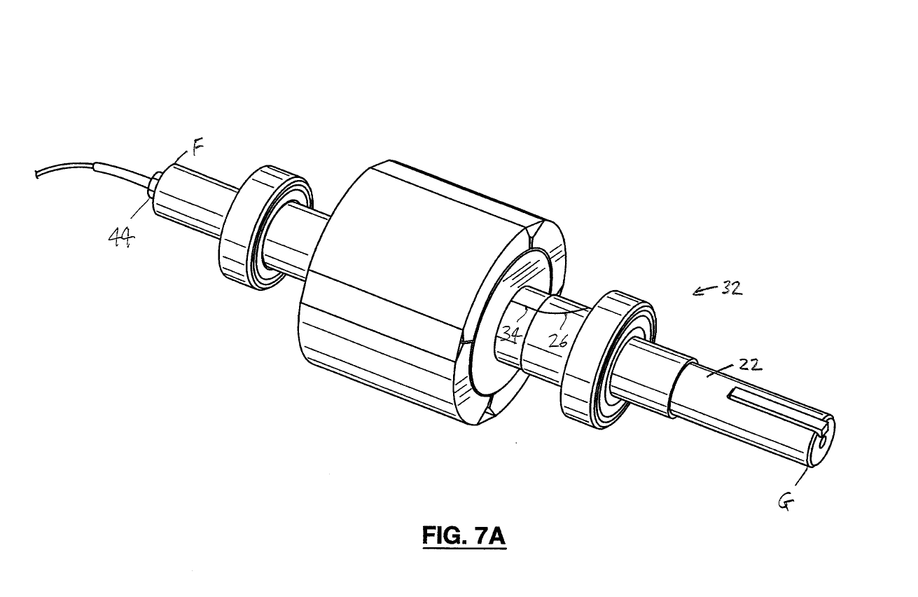

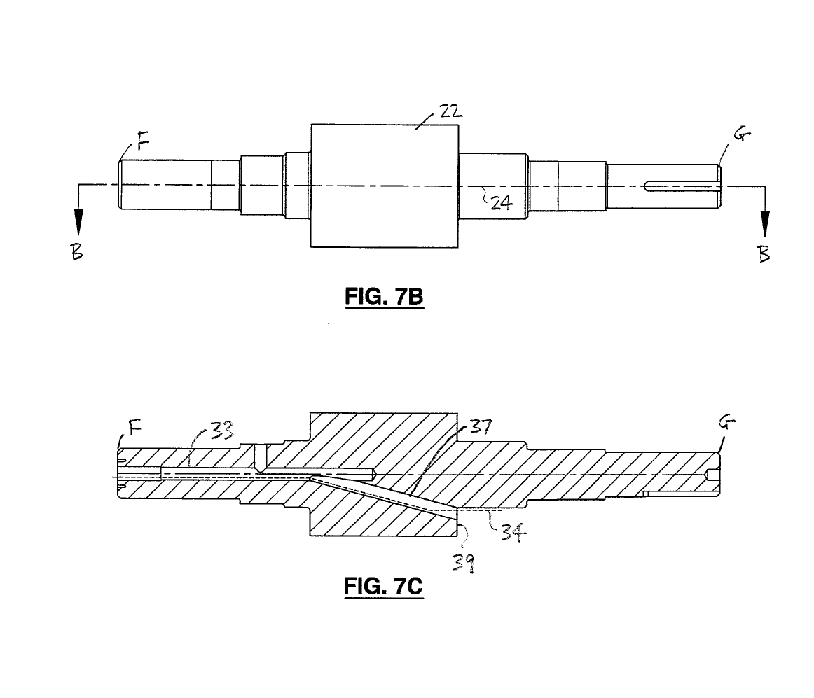

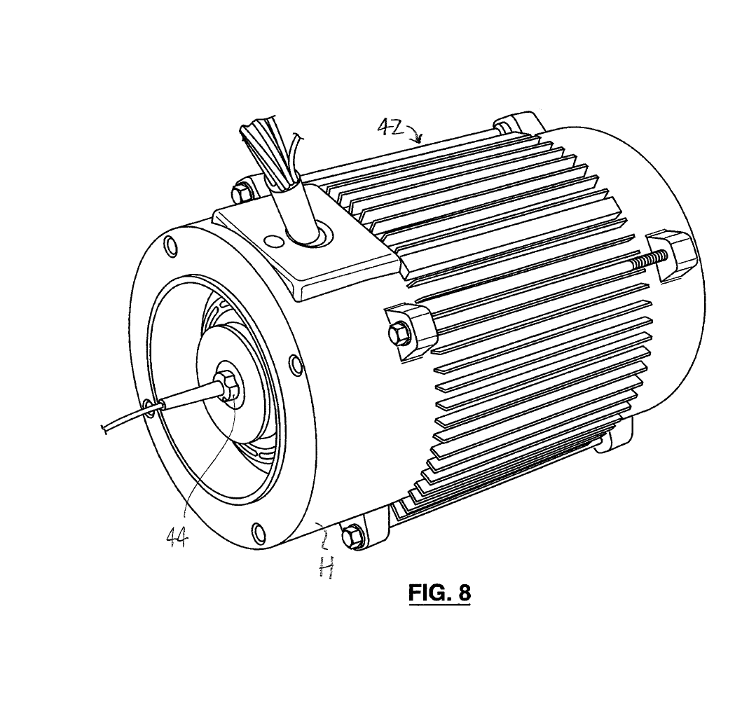

Preferably, the optical circuit 35 is secured to the shaft in any suitable configuration. As can be seen in FIGS. 7A-7C, in one embodiment, the shaft assembly 32 preferably includes the rotatable shaft 22 defining the axis 24 thereof about which the shaft is rotatable and one or more fiber Bragg gratings 26 secured to the shaft 22 so that the fiber Bragg grating 26 is located to define an angle θ of approximately 45° between the fiber Bragg grating 26 and the axis 24. Preferably, the shaft assembly 32 also includes one or more optical fibers 34 secured to the shaft, for transmitting light from the light source 28 (FIG. 3B) to the fiber Bragg grating 26 and for transmitting a modified light resulting from filtering of the light by the fiber Bragg grating 26 therefrom. Those skilled in the art would appreciate that the embodiment illustrated in FIGS. 7A-7C is only one configuration in which the optical circuit 35 is secured to the shaft, and also that many other configurations may be suitable.

From the foregoing, and based on FIGS. 7A-8, it will be understood that the shaft assembly 32 illustrated in FIG. 7A preferably is rotatably mounted in the motor 42 illustrated in FIG. 8. In one embodiment, the electric motor 42 includes the rotatable shaft 22 extending between first and second ends thereof “F” and “G”, means “H” for rotating the shaft, and one or more fiber Bragg gratings 26 secured to the shaft 22. The fiber Bragg grating 26 is positioned so that the fiber Bragg grating 26 is located at least partially non-parallel with the axis 24 of the body 22. The motor 42 also includes one or more optical fibers 34 secured to the shaft 22, for transmitting light from the light source 28 to the fiber Bragg grating 26 at which the light is filtered to provide the modified light. It is also preferred that the motor 42 includes the rotary optical joint 44 through which the light is transmittable to the fiber Bragg grating 26, and through which the modified light is transmittable to the analyzer 30, to determine the torque to which the shaft is subjected.

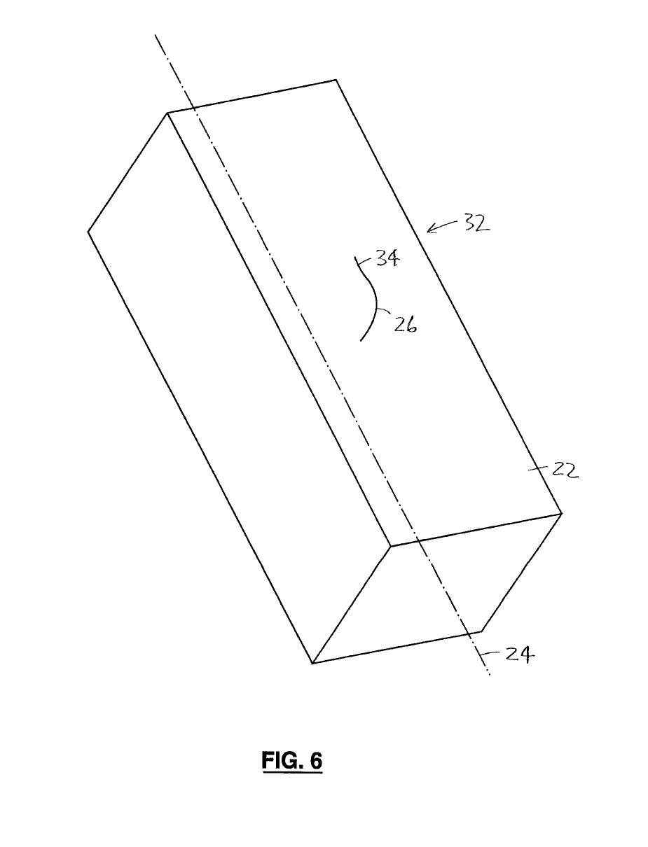

It will also be understood that, although the invention herein is generally described as being used to determine the torque to which a rotatable shaft mounted or positioned for rotation thereof (e.g., in or attached to a motor or other machine) is subjected, the invention may be used in other applications. In particular, the invention herein may be used to determine the torque to which any member (or shaft) is subjected. The shaft 22 is not necessarily a rotatable shaft. That is, the member or shaft in question is not necessarily mounted or positioned for rotation, but may be any element that, in use, may be subjected to torque. For instance, the invention may be used with a non-rotating (i.e., generally substantially stationary) structural member (e.g., a structural member in a bridge) that is subjected to torque. For instance, in FIG. 6, the body 22 is not mounted for rotation, i.e., the body 22 is substantially secured at its ends to other non-rotating elements (not shown in FIG. 6). The optical fiber 34 and the FBG 26 are secured to the body, so that the FBG 26 is located at least partially non-parallel to the axis 24 of the body 22. (It will be understood that a number of elements are omitted from FIG. 6 for clarity of illustration.)

In another example, where a generally stationary member has a rod radially projecting therefrom, a linear force upon the rod is translated into a torque on the member, and in such an arrangement, the torque to which the substantially stationary member is subjected is measurable by the invention herein. Accordingly, notwithstanding the references herein to a “rotatable” shaft herein, it will be understood that the invention may be used to determine torque on members that are not necessarily designed or mounted for rotation.

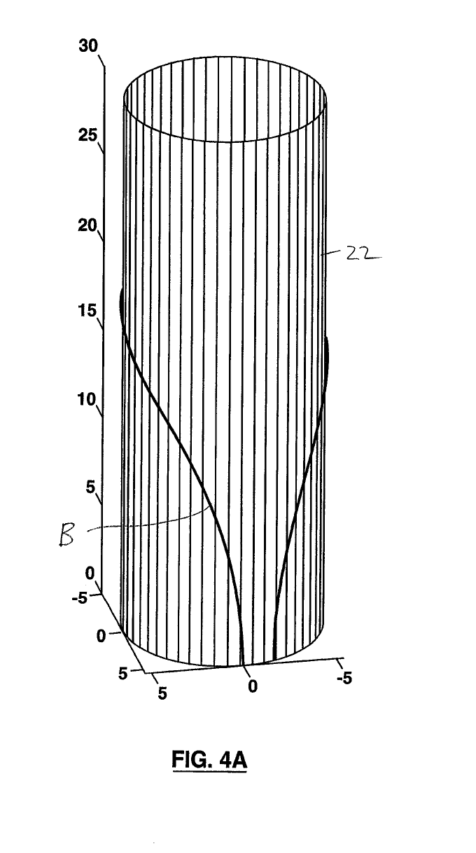

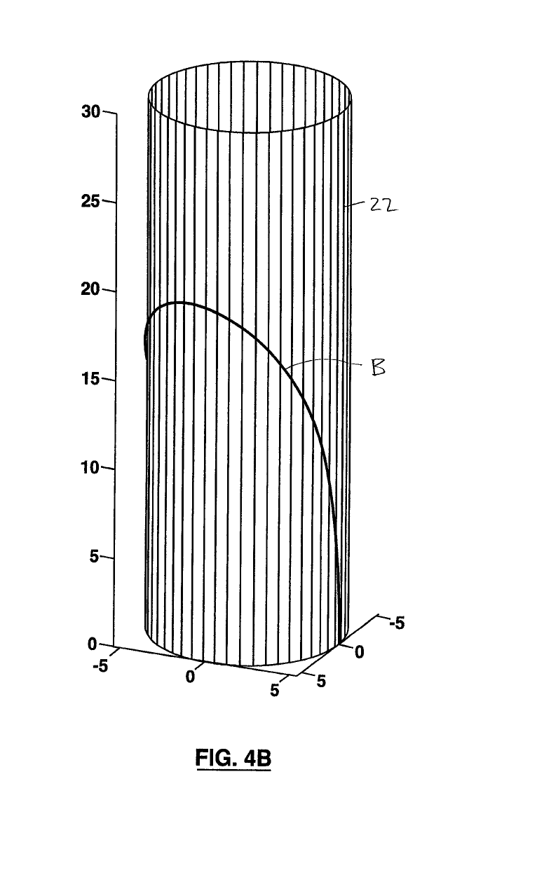

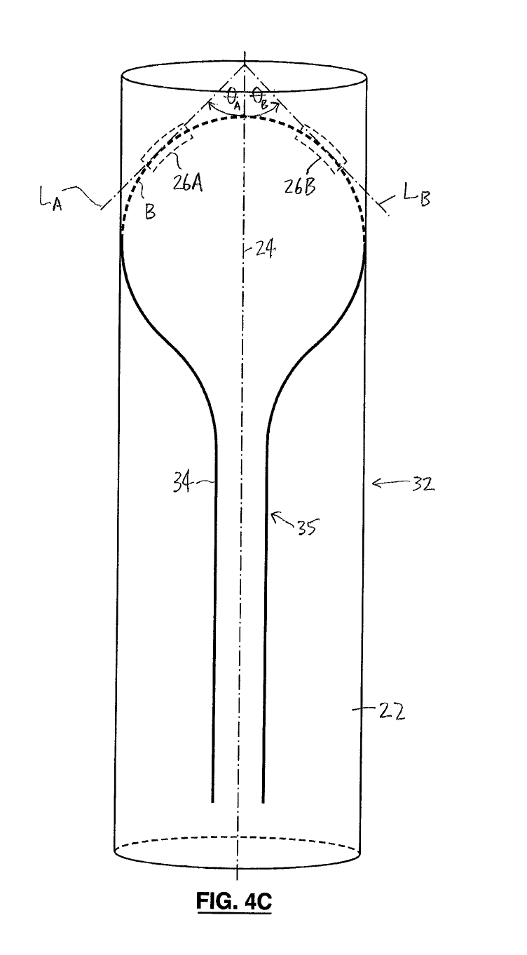

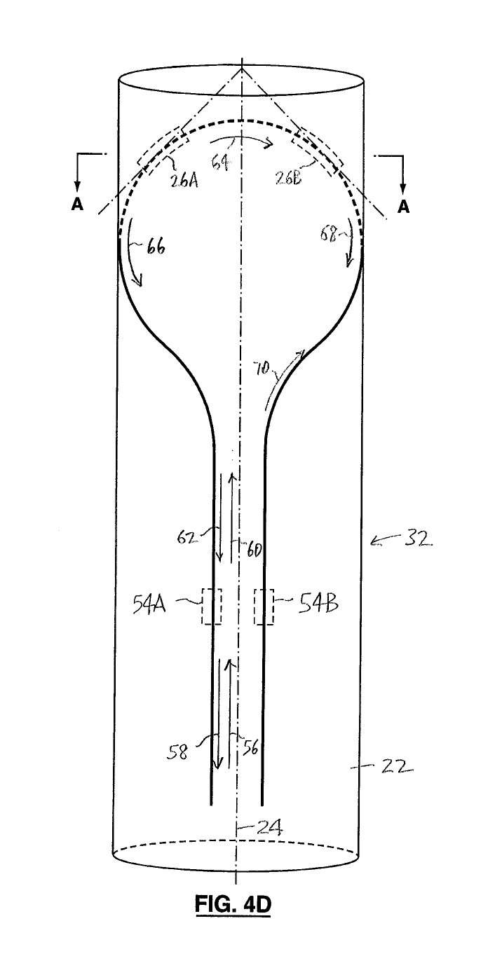

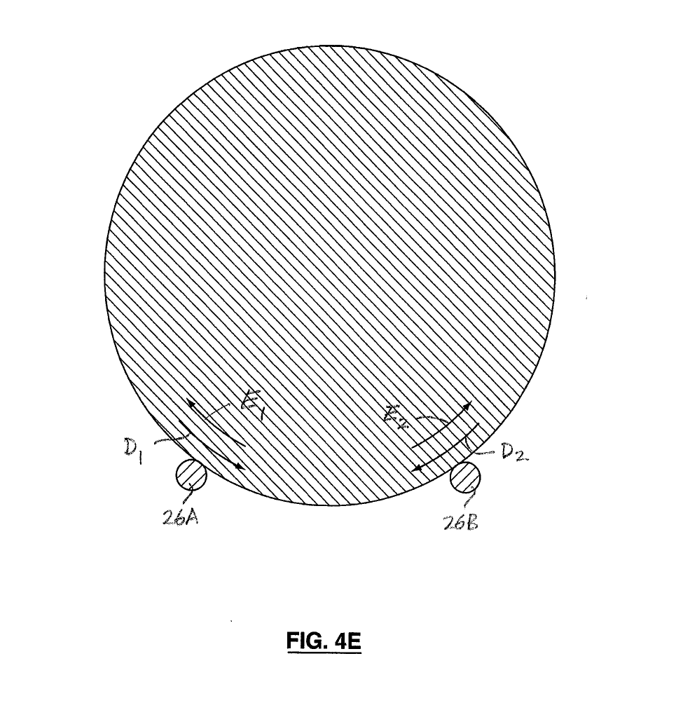

As noted above, in one embodiment, it is preferred that the shaft assembly 32 includes a pair (or more) of FBGs 26 positioned non-parallel to the axis 24. (For clarity, the FBG(s) 26 are sometimes referred to herein as the “first” FBGs.) In one embodiment, and as can be seen in FIG. 4C, the system 20 preferably includes a pair of first fiber Bragg gratings, identified in FIG. 4C by reference numerals 26A and 26B for convenience. Preferably, the pair of first FBGs 26A, 26B is secured to the shaft 22 so that each one of the pair is positioned to define an angle of approximately 45° between each one of the pair and the axis 24, respectively. As noted above, the reflected wavelength of the modified light is broadened by strain, and the maximum strain is measured at 45° relative to the axis 24. As can be seen in FIG. 4C, the pair of FBGs 26A, 26B is positioned symmetrically relative to the axis 24. The optical fiber 34 and the FBGs 26A, 26B define a curve “B”. The substantially straight lines “L_{A}”, “L_{B}” are positioned tangential to the curve “B” at the centers of the first FBGs 26A, 26B to define angles θ_{A}, θ_{B} between the lines “L_{A}”, and “L_{B}” and the axis 24 respectively.

As can be seen in FIG. 4C, part of the optical circuit 35, illustrated by a dashed line, is located on a rear surface of the shaft 22, i.e., the opposed front surface in FIG. 4C facing the observer. The curve “B” on the cylinder body 22 in FIGS. 4A and 4B shows a location of the optical circuit 35 on the cylinder 22 in which the FBGs may be symmetrically located relative to the axis 24.

It is preferred that the pair of FBGs are used in this way for the practical reason that, with data from a pair of FBGs, compensation may be made for optical power fluctuations. Where the analysis of the characteristic spectrum is based on optical power measurement, these fluctuations introduce inaccuracies into the analysis, because they affect the characteristic spectrum in unpredictable ways. Because of the need to compensate for optical power fluctuations in practice when analyzing based on optical power measurement, in one embodiment, it is preferred that a second (reference) FBG is used, to facilitate such compensation. (In the examples illustrated in FIGS. 4C and 4D, the second (reference) FBG is designated by reference numeral 26B.) It has been found that each of the pair of FBGs 26A, 26B preferably are located symmetrically with respect to each other and the axis, as this tends to reduce transient effects.

In one embodiment, the light from the light source 28 (FIG. 3B) preferably is transmitted via the optical fiber 34 to the FBG 26A, as indicated by arrow 46 (FIG. 4C). (The light source 28 and related elements are omitted from FIG. 4C for clarity of illustration.) The modified light created by the FBG 26A is reflected along the optical fiber 34 (as indicated by arrow 48), and is ultimately transmitted to the analyzer 30 for analyzing. The light not reflected by the FBG 26A is transmitted to the second FBG 26B, as indicated by arrow 50 in FIG. 4C. The light reflected by the second FBG 26B is transmitted along the optical fiber 34, as indicated by arrow 52, ultimately being transmitted to the analyzer 30 for analysis thereof. The light not reflected by the second FBG 26B is transmitted therethrough.

Those skilled in the art would appreciate that certain elements in the optical circuit 35 as illustrated in FIG. 4C are exaggerated for clarity of illustration.

In another embodiment, illustrated in FIG. 4D, the system 20 preferably also includes one or more additional second FBGs 54A, 54B secured to the shaft 22 and substantially aligned with the axis 24. (It will be understood that the FBGs 54A, 54B that are substantially aligned with the axis are sometimes referred to as “second” FBGs, to distinguish them from the first FBGs, referred to above.) Preferably, the system includes two second FBGs 54A, 54B positioned symmetrically relative to the axis 24. As will be described, the FBGs 54A, 54B provide data to enable corrections to be made for temperature when the modified light is analyzed. It will be understood that these corrections are to be made only where the intensity of the light from the light source 28 varied depending on wavelength, as described above.

Light from the light source 28 is transmitted along the optical fiber 34 to the FBG 54A, as indicated by arrow 56 in FIG. 4D. (The light source 28 and related elements are omitted from FIG. 4D for clarity of illustration.) The light reflected by the FBG 54A, hereinafter referred to as the “first modified light”, is transmitted along the optical fiber 34 as indicated by arrow 58, to the analyzer 30. The light not reflected by the FBG 54A is transmitted to the FBG 26A, as indicated by arrow 60 in FIG. 4D. The light reflected by the FBG 26A, hereinafter referred to as the “second modified light”, is transmitted along the optical fiber 34 as indicated by arrow 62, to the analyzer 30 (not shown in FIG. 4D).

The light not reflected by the FBG 26A is transmitted to the FBG 26B, as indicated by arrow 64 in FIG. 4D. The light reflected by the FBG 26B, hereinafter referred to as the “third modified light”, is transmitted along the optical fiber 34 as indicated by arrow 66, to the analyzer 30.

The light not reflected by the FBG 26B is transmitted to the FBG 54B, as indicated by arrow 68. The light reflected by the FBG 54B, hereinafter referred to as the “fourth modified light”, is transmitted along the optical fiber 34 as indicated by arrow 70, to the analyzer 30.

In one embodiment, the FBGs 26A, 26B preferably are “pre-torqued”. This has been found to provide the following benefit. When the FBGs are pre-torqued, they tend to provide greater ranges of response than are obtained in the absence of pre-torquing. Because of this, the data from the pre-torqued FBGs can be used to provide a more accurate determination of torque.

FIG. 4E is a cross-section taken along line A-A in FIG. 4D. As can be seen in FIG. 4E, it is preferred that a first selected one of the pair of first FBGs 26A, 26B is pre-torqued in a first rotary direction “D₁”, and a second selected one of the pair of first FBGs 26A, 26B is pre-torqued in a second rotary direction “D₂”, the second rotary direction being substantially opposite to the first rotary direction. For example, in FIG. 4E, the shaft 22 is twisted from a rest position thereof in the direction indicated by arrow “E₁”. While the shaft 22 is held in this twisted state, the FBG 26A is secured to the shaft 22. After the FBG 26A is secured to the shaft 22, the shaft 22 is allowed to return to its rest position. When it is in its rest position, the FBG 26A is twisted as indicated by arrow “D₁” in FIG. 4E.

In the same way, the other FBG 26B preferably is pre-torqued in the opposite direction. The shaft 22 is twisted from its rest position in the direction indicated by arrow “E₂”. While the shaft 22 is held in this twisted state, the FBG 26B is secured to the shaft 22. After the FBG 26B is secured to the shaft 22, the shaft 22 is allowed to return to its rest position. When it is in its rest position, the FBG 26B is twisted as indicated by arrow “D₂” in FIG. 4E.

From the foregoing, it can be seen that, in the embodiment illustrated in FIGS. 4D and 4E, the first, second, third, and fourth modified light each have a characteristic spectrum thereof. Preferably, each of the characteristic spectra is analyzed to determine the torque to which the shaft 22 is subjected.

It would be appreciated by those skilled in the art that any number of FBGs may be utilized, and the order in which the FBGs are positioned relative to the light source is immaterial, as long as the FBGs 26A, 26B are located symmetrically relative to each other. The arrangement of the FBGs as illustrated in FIG. 4D is only one example of a suitable arrangement.

An embodiment of a shaft assembly 32 of the invention is illustrated in FIGS. 7A-7C. The shaft 22 extends between first and second ends “F”, “G” (FIG. 7B). FIG. 7C is a cross-section taken along line B-B in FIG. 7B. As can be seen in FIG. 7C, a hole 33 preferably is drilled coaxial with the shaft 22, from the end “F” toward the other end “G”. A bore 37 is drilled from an outer surface 39 of the shaft 22 to intersect the hole 33. In one embodiment, the optical fiber 34 (represented by a dashed line in FIG. 7C) is fed through the bore 37 from the surface, so that the optical fiber 34 may be operationally connected with the rotary optical joint 44 (not shown in FIG. 7C) at the end “F” of the shaft 22. It will be understood that the optical fiber 34 is positioned in or on the surface (as described above) and optically connected with FBGs. Because rotary optical joints are known in the art, further discussion thereof is unnecessary.

The shaft assembly 32, once assembled (as shown in FIG. 7A), is mounted in the motor 42 (FIG. 8). Those skilled in the art would appreciate that the load to be moved by the motor 42 preferably is connected to the shaft 22 at the end “G” thereof.

Those skilled in the art would be aware that the characteristic spectra may be analyzed in various ways, and the analyzer 30 may include different components, depending on the light source and the technique of analysis that have been selected. As noted above, in any particular application, the light source and the techniques of analysis may be selected based on a number of factors. The FBG reflection (or transmission, as the case may be) spectrum broadening can be measured using any suitable means, e.g., optical spectrum analyzers, FBG interrogation systems, or optical power detector systems, as will be described. Accordingly, in one embodiment, the analyzer 30 preferably includes a FBG demodulation system selected from the group consisting of an optical spectrum analyzer, a FBG interrogation system, and an optical power-based analysis system. It would be appreciated by those skilled in the art that the foregoing is a list of alternative systems that may be used.

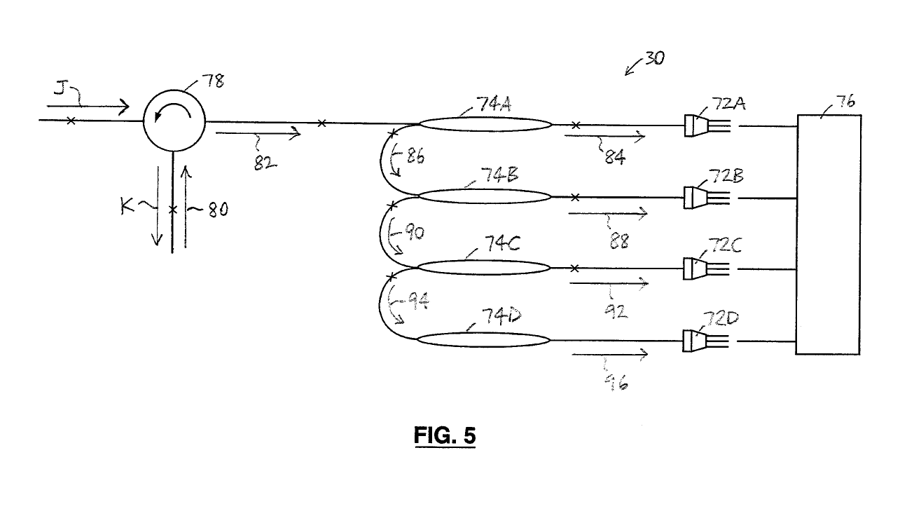

The following description is of one embodiment of the analyzer 30, in which the light originates from an ASE light source. In this embodiment, the analyzer is an optical power detector system. Accordingly, it will be understood that the following description is exemplary only. Signal conditioning preferably is among the tasks performed by the analyzer 30 (FIG. 5). In one embodiment, as schematically illustrated in FIG. 5, the analyzer 30 preferably includes one or more photodiodes (four of which are identified in FIG. 5 by reference numerals 72A-72D), for converting the modified light to electrical signals corresponding thereto. Preferably, the analyzer also includes one or more wavelength demultiplexers (WDM) (four of which are identified in FIG. 5 by reference numerals 74A-74D) for providing the characteristic spectrum of the modified light to the photodiodes 72A-72D. It is also preferred that the analyzer 30 includes one or more processors 76, for analyzing the characteristic spectrum and determining the torque which resulted in the characteristic spectrum.

It will be appreciated by those skilled in the art that, as schematically illustrated in FIG. 5, the system 20 preferably also includes an optical circulator 78 for transmitting the modified light to the analyzer 30.

In summary, in the embodiments illustrated in FIGS. 5 and 9-12, broadband light produced by ASE is utilized, and WDMs and photodiodes are used to demodulate the sensors. The elements utilized and the techniques employed in this embodiment may be selected, for instance, due to their relatively low cost. Those skilled in the art would appreciate that among the alternative techniques and elements are the following examples:
using a spectrum analyzer (i.e., instead of the WDMs and the photodiodes);
using FBG interrogation systems (also referred to as FBG interrogators);
using a spectrum analyzer to analyze light produced by a tunable laser;
using photodiodes to analyze light produced by a tunable laser; and
using a tunable filter and photodiodes to analyze light produced by a broadband light.

For the foregoing reasons, it will be understood that the following description of the features and elements illustrated or represented in FIGS. 5 and 9-12 is exemplary only.

### INDUSTRIAL APPLICABILITY

In use, light generated by the light source 28 is transmitted to the optical circuit 35 via the optical circulator 78, as indicated by arrows “J” and “K” in FIG. 5. Referring to the embodiment of the shaft assembly 32 illustrated in FIG. 4D, the first, second, third, and fourth modified light from each of FBGs 54A, 26A, 26B, and 54B respectively is transmitted via the optical fiber 34 of the shaft assembly 32, and also via the rotary optical joint 44, to the optical circulator 78, as indicated by arrow 80. In one embodiment (illustrated in FIG. 5), the first, second, third, and fourth modified light preferably is transmitted by the optical circulator 78 to the WDM 74A, as indicated by arrow 82. The WDM 74A preferably separates the first modified light from the second, third, and fourth modified light, and transmits it to the first photodiode 72A, as indicated by arrow 84. The signals characteristic of the characteristic spectrum for the first modified light preferably are then transmitted from the photodiode 72A to the processor 76 for processing, as will be described.

Referring to FIG. 5, the second, third, and fourth modified light preferably is transmitted from the WDM 74A to the WDM 74B, as indicated by arrow 86. The WDM 74B preferably separates the second modified light from the third and fourth modified light, and transmits it to the second photodiode 72B, as indicated by arrow 88. The signals characteristic of the characteristic spectrum for the second modified light preferably are then transmitted from the photodiode 72B to the processor 76.

The third and fourth modified light preferably is transmitted from the WDM 74B to the WDM 74C, as indicated by arrow 90 in FIG. 5. The WDM 74C preferably separates the third modified light from the fourth modified light, and transmits it to the third photodiode 72C, as indicated by arrow 92. The signals characteristic of the characteristic spectrum for the third modified light preferably are then transmitted from the photodiode 72C to the processor 76.

The fourth modified light preferably is transmitted from the WDM 74C to the WDM 74D, as indicated by arrow 94 in FIG. 5. The WDM 74D preferably separates the fourth modified light, and transmits it to the fourth photodiode 72D, as indicated by arrow 96. The signals characteristic of the characteristic spectrum for the fourth modified light preferably are then transmitted from the photodiode 72D to the processor 76.

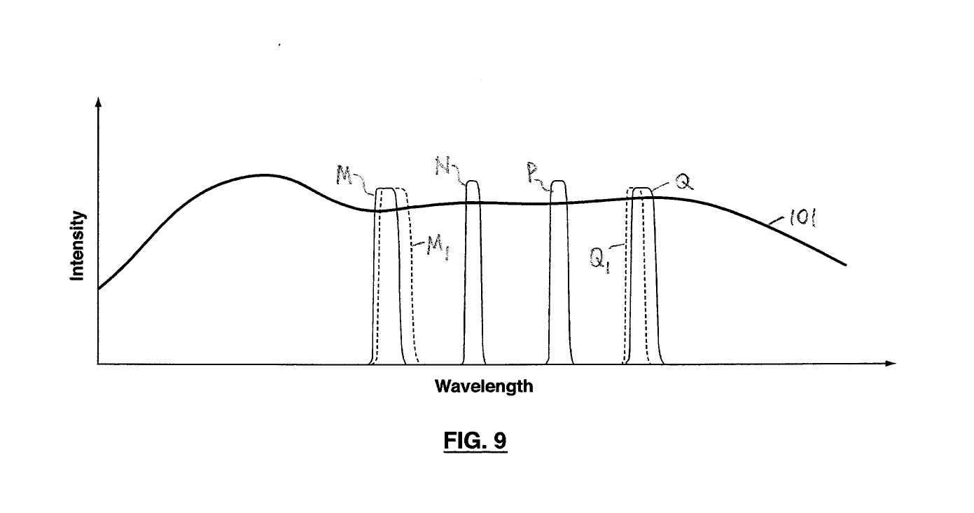

In one embodiment, it is also preferred that the processor 76 is programmed to process the signals in order to generate the characteristic spectra. Examples of characteristic spectra are provided in FIGS. 9-11.

In the examples provided in FIGS. 9-11, the light is produced using ASE (amplified spontaneous emission). A line identified by reference numeral 101 in each of FIGS. 9-11 represents the ASE light source spectrum when the shaft 22 is at room temperature and the shaft 22 is subjected to zero torque. Those skilled in the art would appreciate that light that is from other light sources (i.e., not necessarily broadband light) may be utilized. Such other light would have other spectra accordingly. The spectra illustrated in FIGS. 9-11 are exemplary only, as would be appreciated by those skilled in the art.

The characteristic spectra associated with FBGs 26A, 54A, 54B, and 26B respectively are identified in FIGS. 9-11 by reference letters “M”, “N”, “P”, and “Q”. As can be seen in FIG. 11, temperature shifts all of the spectra equally.

In FIG. 9, the effect of positive torque is seen. (For the purposes hereof, “positive torque” refers to twisting the shaft in a selected direction.) The characteristic spectrum “M” (associated with FBG 26A) is broadened to define a slightly broader shape (illustrated in dashed lines), identified as “M₁”, that is partially shifted to the right. The characteristic spectrum “Q” (associated with FBG 26B) is slightly narrowed, and the narrower form (also illustrated in dashed lines) is identified by “Q,”, and is partially moved to the left.

Those skilled in the art would appreciate that the foregoing results are due to the FBGs 26A, 26B being pre-torqued in opposite directions. When the shaft is twisted in one direction, then one of the pair of pre-torqued FBGs will be broadened, and simultaneously, the other FBG will be narrowed.

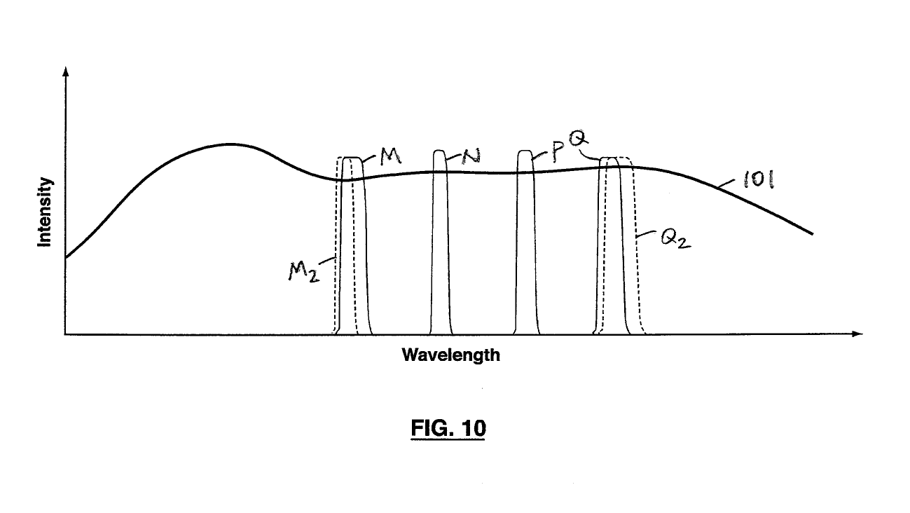

In FIG. 10, the effect of negative torque is shown. (For the purposes hereof, “negative torque” refers to twisting the shaft in a direction opposite to the previously-mentioned selected direction.) In this situation, the characteristic spectrum “M” (associated with FBG 26A) is broadened to define a slightly narrower shape (illustrated in dashed lines), identified as “M₂”, that is partially shifted to the left. However, the characteristic spectrum “Q” (associated with FBG 26B) is broadened, and the broader form (also illustrated in dashed lines) is identified by “Q₂”, and is partially moved to the right.

In FIG. 11, the effect of temperature is shown. Due to an increase in the temperature of the shaft, each of the characteristic spectra “M”, “N”, “P”, and “Q” is shifted to the right, as shown by the characteristic spectra illustrated in dashed lines and identified as “M₃”, “N₃”, “P₃”, and “Q₃” respectively. The spectra are not broadened or narrowed due to the effect of temperature.

As noted above, the shifts due to temperature increase because of the non-flat nature of the curve 101 in FIG. 11, which shows how the ASE light's intensity varies according to wavelength.

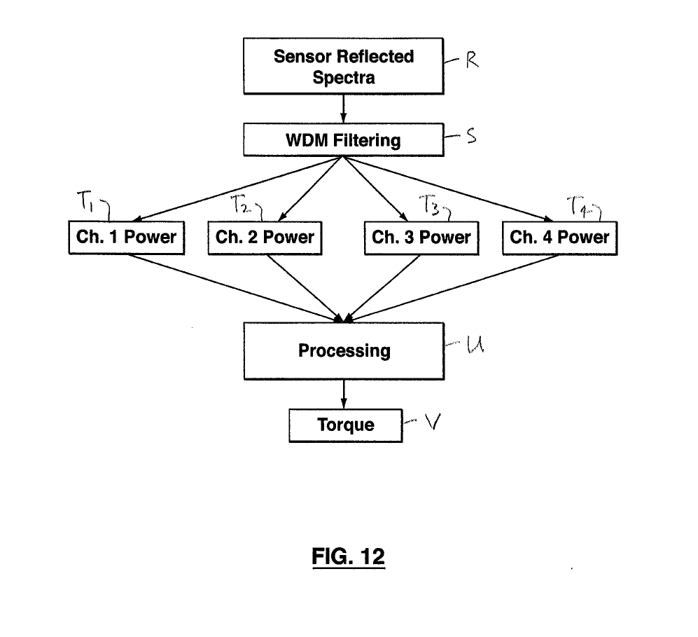

The signal conditioning and processing performed by the analyzer 30 are schematically represented in FIG. 12, for the embodiment of the system including the ASE light source, the four FBGs, as described above, and also the embodiment of the analyzer illustrated in FIG. 5. In this embodiment, the characteristic spectra (referred to as “R”) are transmitted to the WDMs 74A-74D, for WDM filtering (referred to as “S” in FIG. 12), resulting channels 1 through 4 power (referred to as “T₁”-“T₄” respectively). The signals therefrom are processed (“U”) by the processor 76 to result in the determined torque (“V”).

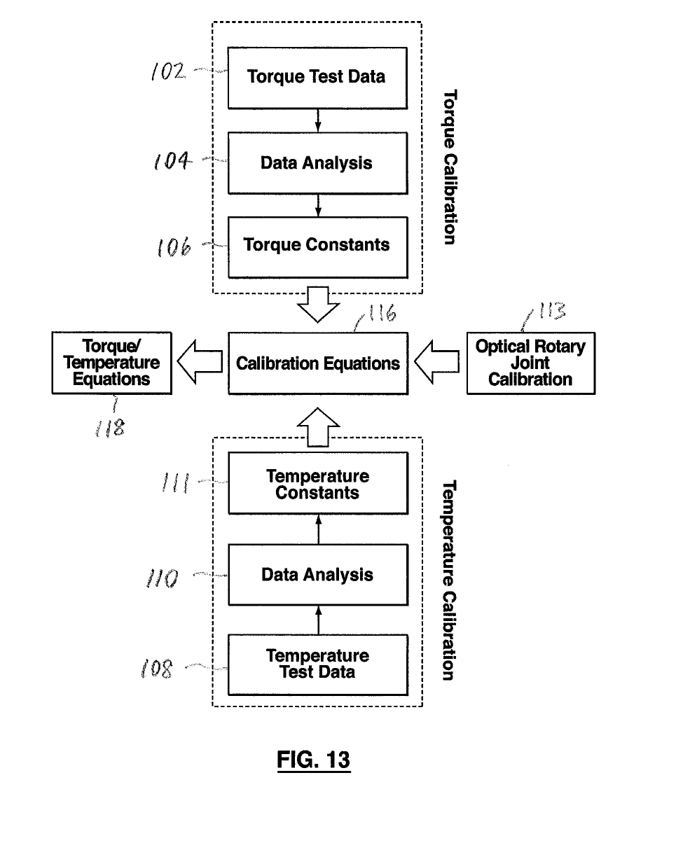

Those skilled in the art would appreciate that the processing by the processor 76, in one embodiment, preferably includes a number of steps (FIG. 13). Calibration of the system 20 is done before torque can be determined, as would be known by those skilled in the art. For instance, for torque calibration, torque test data 102 is subjected to analysis 104 to provide torque constants 106 for a selected system. For the reasons set out above, it will be understood that the selected system may not necessarily include the embodiment of the analyzer illustrated in FIG. 5.

As described above, in one embodiment (i.e., where ASE light is used), it is preferred that an adjustment is made for temperature. For temperature calibration, temperature test data 108 is subjected to analysis 110 to provide temperature constants 111 for the selected system 20.

In addition, the optical rotary joint is calibrated 113.

Preferably, the torque and temperature constants and the optical rotary joint calibration data are used, via calibration equations 116, to provide torque/temperature equations 118 for use with the selected system 20. The torque/temperature equations thus completed preferably are used to process the signals resulting from the signal conditioning described above to determine the torque to which the shaft is subjected. Because those skilled in the art would be aware of the techniques involved, it is unnecessary to describe them in more detail.

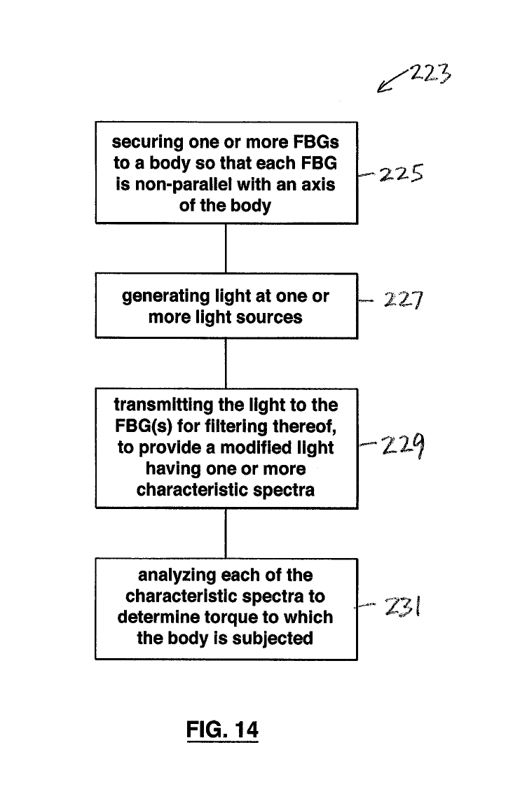

The invention also includes an embodiment of a method 223 of the invention for measuring the torque to which the body 22 is subjected by twisting the body 22 about the axis 24 defined thereby. As can be seen in FIG. 14, the method 223 preferably includes, first, securing one or more fiber Bragg gratings 26 to the body 22 so that the fiber Bragg grating is non-parallel with the axis of the body (step 225, FIG. 14). Light is generated by one or more light sources 28 (step 227). The light is transmitted to the fiber Bragg grating(s) 26 for filtering of the light thereby to provide a modified light having one or more characteristic spectra (step 229). The characteristic spectrum is analyzed to determine the torque to which the body is subjected (step 231).

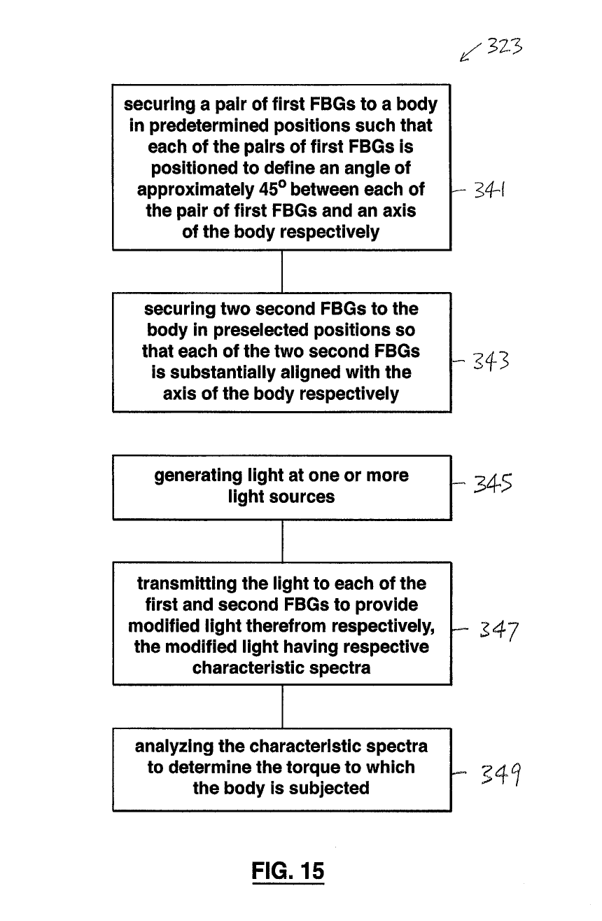

Another embodiment of the method 323 of the invention is illustrated in FIG. 15. The method 323 preferably includes the steps of, first, securing a pair of first fiber Bragg gratings 26A, 26B to the body 22 in predetermined positions so that each one of the pair of first fiber Bragg gratings is positioned to define an angle of approximately 45° between each one of the pair of first fiber Bragg gratings and the axis of the body respectively (FIG. 15, step 341). Also, two second fiber Bragg gratings 54A, 54B are secured to the body in preselected positions so that each of the two second fiber Bragg gratings is substantially aligned with the axis of the body respectively (step 343). Light is generated by one or more light sources (step 345). The light is transmitted to each of the first and second fiber Bragg gratings for filtering of the light thereby respectively to provide modified light from each of the first and second fiber Bragg gratings respectively, the modified light having respective characteristic spectra (step 347). The characteristic spectra are analyzed to determine the torque to which the body is subjected (step 349).

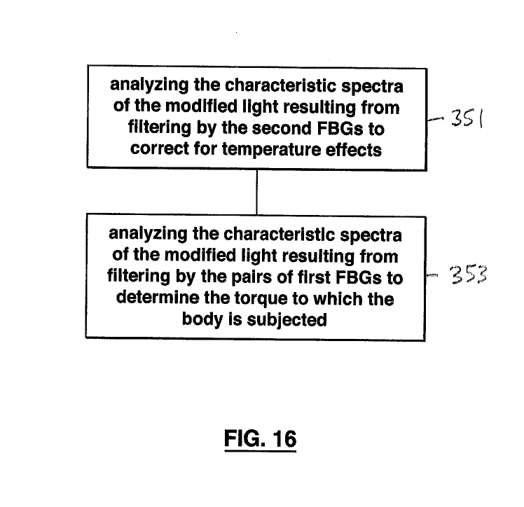

In one embodiment, the method 323 preferably includes analyzing the characteristic spectra of the modified light resulting from filtering by the two second fiber Bragg gratings 54A, 54B to correct for temperature effects (FIG. 16, step 351). Also, the characteristic spectra of the modified light resulting from filtering by the pair of first fiber Bragg gratings 26A, 26B to determine the torque to which the body is subjected (step 353).

It will be appreciated by those skilled in the art that, although steps 341 and 343 are shown in a particular sequence in FIG. 15, the sequence of these steps is not functionally significant, i.e., step 343 could precede step 341. Also, although step 351 is shown as preceding step 353 in FIG. 16, step 353 could precede step 351.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

1. A measuring system for measuring torque to which a body is subjected by twisting the body about an axis defined thereby, the system comprising:
a pair of first fiber Bragg gratings secured to the body, each of said first fiber Bragg gratings being respectively positioned on the body to at least partially define a curve;
at least one light source for providing light transmittable to each said fiber Bragg grating;
the light transmitted to each said fiber Bragg grating being filtered thereby to provide a modified light having at least one characteristic spectrum; and
an analyzer for analyzing said at least one characteristic spectrum from each said first fiber Bragg grating to determine the torque to which the body is subjected.

2. (canceled)

3. (canceled)

4. A measuring system according to claim 1 in which a substantially straight line tangential to the curve defined by each said first fiber Bragg grating respectively defines an angle between the line and the axis of the body that is approximately 45°.

5. A measuring system according to claim 1 in which said at least one light source is selected from the group consisting of a light-emitting diode, a tunable laser, a Fabry-Perot laser, and a super-luminiescent diode.

6. A measuring system according to claim 1 in which the body is a rotatable shaft.

7. A measuring system according to claim 6 in which the rotatable shaft is driven by a motor in which the rotatable shaft is mounted.

8. A measuring system according to claim 7 in which the light and the modified light are transmitted via at least one optical fiber.

9. A measuring system according to claim 8 in which the light from said at least one light source is transmitted to said at least one optical fiber via a rotary optical joint.

10. (canceled)

11. A measuring system according to claim 6 additionally comprising:
at least one second fiber Bragg grating secured to the shaft and substantially aligned with the axis.

12. A measuring system according to claim 6 additionally comprising two second fiber Bragg gratings secured to the shaft, each of the two second fiber Bragg gratings being substantially aligned with the axis respectively, and the two second fiber Bragg gratings being positioned symmetrically relative to the axis.

13. A measuring system according to claim 12 in which:
a first selected one of said pair of first fiber Bragg gratings is pre-torqued in a first rotary direction; and
a second one of said pair of first fiber Bragg gratings is pre-torqued in a second rotary direction substantially opposite to the first rotary direction.

14. A measuring system according to claim 1 in which the analyzer comprises a FBG demodulation system selected from the group consisting of an optical spectrum analyzer, a FBG interrogation system, and an optical power-based analysis system.

15. A measuring system according to claim 1 in which the analyzer comprises:
at least one photodiode, for converting the modified light to electrical signals corresponding thereto;
at least one means for providing said at least one characteristic spectrum of the modified light to said at least one photodiode, for conversion thereby; and
at least one processor, for analyzing said at least one characteristic spectrum and determining the torque which resulted in said at least one characteristic spectrum.

16. A measuring system according to claim 1 additionally comprising an optical circulator for transmitting the modified light to the analyzer.

17. A method of measuring torque to which a body is subjected by twisting the body about an axis defined thereby, the method comprising the steps of:
(a) securing a pair of first fiber Bragg gratings to the body to position each said first fiber Bragg grating respectively to at least partially define a curve;
(b) generating light at at least one light source;
(c) transmitting the light to each said fiber Bragg grating for filtering of the light thereby to provide a modified light having at least one characteristic spectrum; and
(d) analyzing said at least one characteristic spectrum from each said first fiber Bragg grating respectively to determine the torque to which the body is subjected.

18. A method of measuring torque to which a body is subjected by twisting the body about an axis defined thereby, the method comprising the steps of:
(a) securing a pair of first fiber Bragg gratings to the body in predetermined positions such that each one of said pair of first fiber Bragg gratings is respectively positioned to define a curve;
(b) securing two second fiber Bragg gratings to the body in preselected positions such that each of said two second fiber Bragg gratings is substantially aligned with the axis of the body respectively;
(c) generating light at at least one light source;
(d) transmitting the light to each of said first and second fiber Bragg gratings for filtering of the light thereby to provide modified light from each of said first and second fiber Bragg gratings respectively, said modified light having respective characteristic spectra; and
(e) analyzing said characteristic spectra to determine the torque to which the body is subjected.

19. A method according to claim 18 in which step (e) comprises the additional steps of:
(e.1) analyzing the characteristic spectra of the modified light resulting from filtering by said two second fiber Bragg gratings to correct for temperature effects; and
(e.2) analyzing the characteristic spectra of the modified light resulting from filtering by said pair of first fiber Bragg gratings to determine the torque to which the body is subjected.

20. (canceled)

21. (canceled)

22. A measuring system according to claim 1 in which the pair of first fiber Bragg gratings is positioned symmetrically relative to the axis.
